(19) United States
(12) Patent Application Publication
(10) Pub. No.: US 2014/0019309 A1
(43) Pub. Date: Jan. 16, 2014

(54) Online Virtual Mall

(71) Applicant: Dana Michelle Hawkins, Enlgwood, CO (US)

(72) Inventor: Dana Michelle Hawkins, Enlgwood, CO (US)

(21) Appl. No.: 13/461,837

(22) Filed: Jul. 16, 2012

(51) Int. Cl. G06Q 30/06

(52) U.S. Cl. CPC G06Q 30/0643
USPC 705/27.2

(57) ABSTRACT

An online virtual mall is a website, video game, or arcade that allows shoppers to shop and purchase items, as if they were in a real commercial mall. The online virtual mall contains more than two vendors or companies. The vendors or companies are obtained for the online virtual mall via affiliate programs, or individual contracts between the operators and developers of the website, video game or arcade, and the vendors or companies. Visitors will enter into the website, video game or arcade to shop and purchase product from individual vendors or companies. The vendors or companies will be responsible for billing and shipping of their products.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The field of endeavor relates to the development and operation of a website as an online virtual mall. The applicable U.S. patent classification is 705/26.1. The class 705 is data processing for financial, business practice, management, and cost or price determination. The subclass 26.1 refers to a computerized arrangement which enables a shopper to investigate, locate, specify, requisition, order, or purchase one or more items for sale or trade, by using a device configured to include telecommunications functionality for the exchange of information concerning the one or more items.

Originally online shopping was a tedious task. An individual would be required to know and type multiple website addresses. An individual would not be able to comparison shop. An online shopper spends a lot of time looking and searching for their favorite stores. Some shopping sites have such a high volume of inventory that it makes shopping overwhelming. Small commercial malls are being replaced with huge mega-malls, which are not known for their convenience.

### BRIEF SUMMARY OF THE INVENTION

An online virtual mall is a website, video game, or arcade that allows shoppers to shop and purchase items, as if they were in a real commercial mall. The online virtual mall contains more than two vendors or companies. The vendors or companies are obtain for the online virtual mall via affiliate programs, or developers of the website, video game or arcade; and the vendors or companies. Visitors will enter into the website, video game or arcade to shop and purchase product from individual stores. The vendors or companies will be responsible for billing and shipping of their products.

### BRIEF DESCRIPTION OF THE SEVERAL VIEWS OF THE DRAWING

FIG. 1 shows various aspects on how to display the vendor or company on the online virtual mall.

FIG. 2 shows various aspects on how to obtain hyperlinks of the vendors or the companies.

### DETAILED DESCRIPTION OF THE INVENTION

[0004]The virtual online mall resembles a commercial mall. The virtual online mall is a website, arcade, video game that allows individuals to shop. The virtual online mall has two or more vendors on the website, arcade or video game. The vendors are obtained for the online virtual mall via affiliate programs, a vendors or a company affiliate program, vendors or companies paying for advertising space, or private contracts between the vendor or company, and the online virtual mall. The virtual online mall allows individuals to have the convenience of the commercial mall. The online virtual mall provides a one-stop shopping experience.

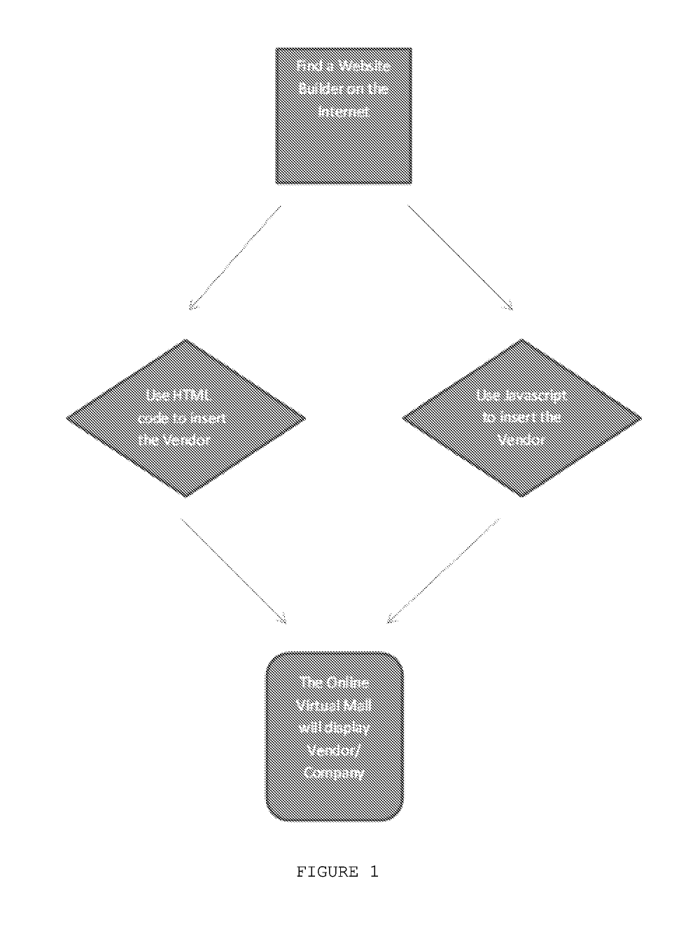

As shown in FIG. 1, the virtual online mall is developed through computer programs. An individual can develop the website, arcade or videogame through a program that helps build websites or a person who is hire those skills. The website builders are found on the Internet. The program will be created using more than one vendor or company being display on a website, arcade or video game. The vendors or company will be placed in the website program through the use of a “hyperlink”. A “hyperlink” was developed by Sir Timothy John “Tim” Berners-Lee. The “hyperlink” is use to link any information to any other information over the Internet. The website's pages are written in the hypertext mark-up system “HTML”. Hypertext is text with hyperlinks. The purpose of a web browser is to read “HTML” documents and compose them into visible or audible web pages. Hyperlinks present in websites enable users easily to navigate their browsers to the related resources (vendor or company). A web browser can also be defined as application software or program designed to enable users to access, retrieve, view documents and other resources on the Internet. The other hyperlink that can be use along with the “HTML” is “JavaScript” hyperlink. The “JavaScript” was developed by Brendon Eich. “JavaScript” has become one of the most popular programming languages on the web. The “JavaScript” hyperlink can also be place within the website's design to display the vendor or company.

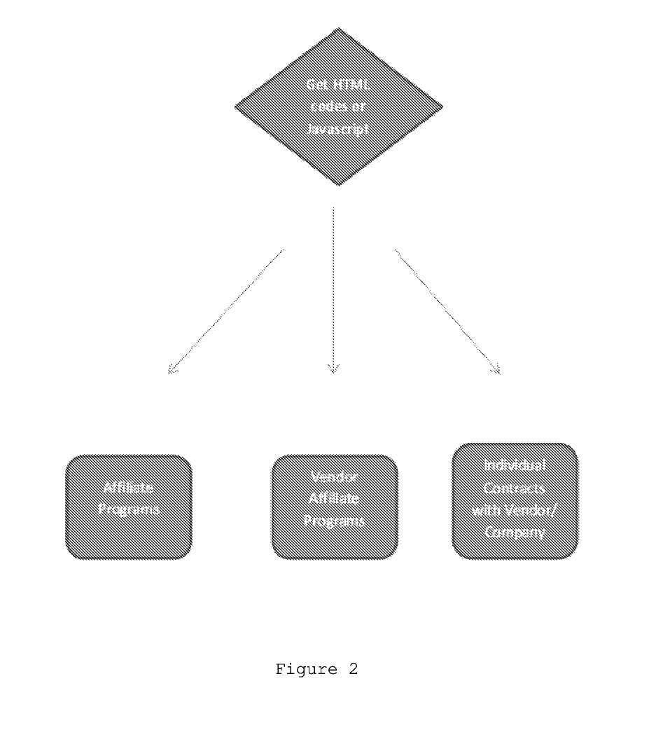

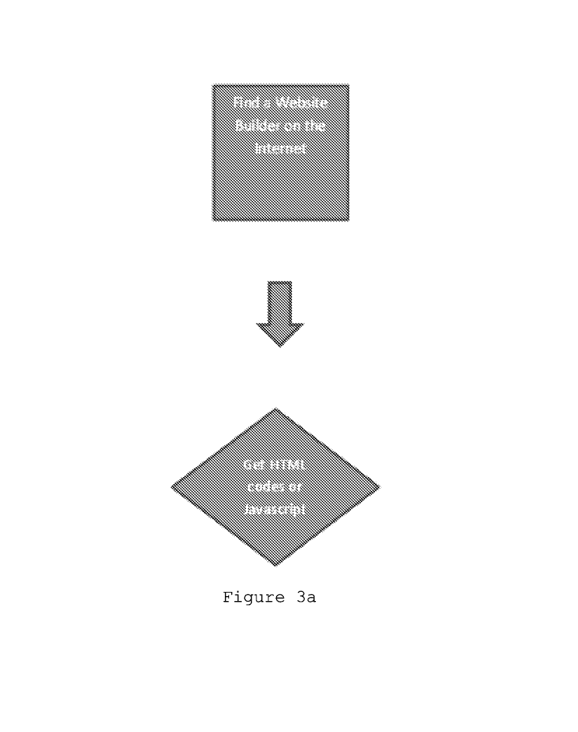

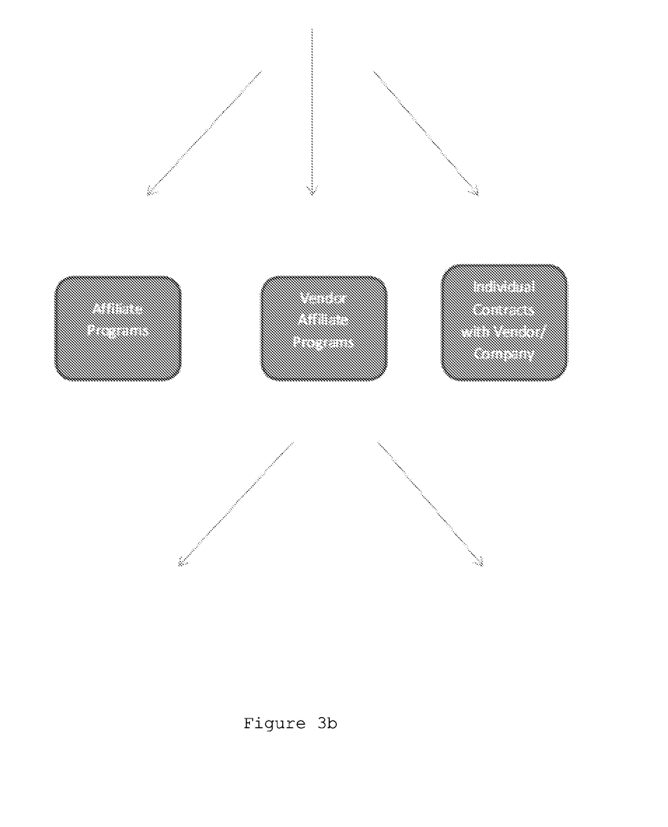

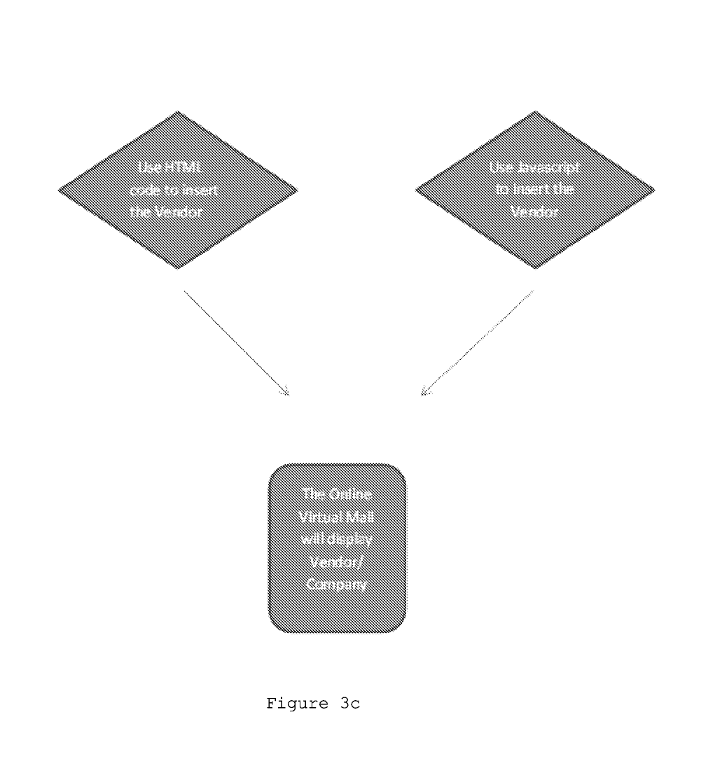

As shown in FIG. 2, the online virtual mall is able to receive its hyperlinks via affiliate programs. The affiliate programs can be obtained by registering with a company that allows the developer of the website to become a part of their program. There are a number of Internet companies that provide the latter service for example, Amazon, Commission Junction, Linkshare, and Google Affiliate Program (GAN), etc. The developer of the online virtual mall would register to one or more of these affiliate Internet companies. The affiliate program companies would approve their entrance into the program. Then the developer would apply to a list of vendor or companies provided to then through the affiliate program. Those vendors or companies would review, and approve the application provide by the online virtual mall. Once approve by the vendors or companies the affiliate program represent; they would give the developer of the online virtual mall the vendors' or companies' hyperlinks. The developer of the online virtual mall he would then proceed to copy and paste the hyperlinks provided to them, into the design of the webpage in the website builder.

As shown in FIG. 2, the online virtual mall is able to receive their hyperlinks through the vendor or company they are interested in displaying on the website, arcade or videogame. The vendors or companies can have their very own affiliate programs. The developer would contact the vendor or company they would like to display on the virtual online mall, and apply for the vendor's or company's affiliate program. The vendors or companies would then have option to approve the application for the online virtual mall, and in doing so give the online virtual mall the hyperlink for the website's webpage.

As shown in FIG. 2, the online virtual mall able to receive their hyperlinks through vendors or companies that pay for advertising space on the website. The vendor or company would provide a contract agreement with the online virtual mall. The vendor or company would pay the online virtual mall to allow the latter to take up space on the website, arcade, or videogame. The vendor or company would then provide the hyperlinks to the developer of the online virtual mall; to copy and paste into the design of the webpage of the website.

The online virtual mall saves time and money. Individuals will have the freedom to comparison shop in a time saving, and efficient manner. A shopper can visit all their favorite stores in one place. The online virtual mall is also an convenience for those who are not able to go to a commercial mall. The hyperlinks of the vendors or companies are copied and pasted into a website, arcade and videogame. The online virtual mall obtains hyperlinks through an affiliate programs, a vendor or company affiliate program and a contract agreement with a vendor or company.

I claim:

1. A method of an online virtual mall comprising a mall that is developed through computer programs.

2. The method of providing said online virtual mall as an website, videogame or arcade such that as a commercial mall.

3. The method of claim 2 providing wherein said website, arcade or videogame through a program that helps build websites for said online virtual mall.

4. The method of claim 3 providing wherein said program for website builders are on the internet for said online virtual mall.

5. The method of providing individuals a first means to shop and purchase items.

6. The method of providing said online virtual mall that contains a plurality of vendors or companies.

7. The method of claim 6 providing wherein said vendors or companies are obtain for said online virtual mall through affiliate programs.

8. The method of claim 6 further including said vendors or companies are obtain by individual contracts between the operators and developers of the website, video game or arcade, and said vendors or companies; for said online virtual mall.

9. The method of claim 6 further including said vendors or companies will be placed in the website program through the use of a hyperlink for said online virtual mall.

10. The method of claim 6 further including said vendors or companies would then provide the hyperlinks to the developer of the online virtual mall; to copy and paste into the design of the webpage of the website of the said online virtual mall.

11. The method of providing individuals the second means to enter into said website, video game, or arcade to shop and purchase products of vendors, or companies from said virtual online mall.

12. The method of providing said vendors or companies the third means for billing, and shipping of their products to the customers of said online virtual mall,
whereby said online virtual mall will provide the convenience of one stop shopping and cost efficiency.
